(19) United States
(12) Patent Application Publication
(10) Pub. No.: US 2007/0249195 A1
(43) Pub. Date: Oct. 25, 2007

(54) Dummy Terminal

(75) Inventors: Shinji Tomita, Yokosuka-shi (JP); Noboru Tuchiya, Yokohama-shi (JP); Norihiro Suzuki, Asaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC21 CO., LTD., Yokosuka-shi (JP)

(21) Appl. No.: 10/580,539

(22) PCT Filed: Nov. 24, 2004
(86) PCT No.: PCT/JP04/17819

§ 371 Date: Mar. 19, 2007

(30) Foreign Application Priority Data
Nov. 26, 2003 (JP) 2003-435321
Nov. 26, 2003 (JP) 2003-273508

(51) Int. Cl. H01R 13/443

(52) U.S. Cl. 439/148

(57) ABSTRACT

Disclosed is a dummy terminal, which is capable of being inserted in a lockable manner into a connector-terminal socket, instead of a cable connector terminal, so as to prevent a cable connector terminal from being erroneously inserted into an improper or unauthorized connector-terminal socket which has no cable connector terminal connected thereto. The dummy terminal 10 comprises a dummy terminal body 12, a thin plate member 13, an engagement member 14 and a set screw 30. The dummy terminal body 12 is generally composed of a grooved frame defined by opposite side walls 12A, 12B and top wall 12C, and a front wall 12D formed at a front end of the grooved frame. The thin plate member 13 is generally composed of an anchor portion 13A to be mounted on the front wall 12D, and a restraint portion 13B for placing an engaged state of the engagement member 14 under restraint.

### TECHNICAL FIELD

The present invention relates to a dummy terminal designed to be used instead of a connector terminal attached to an end of a signal transmission cable, and inserted in a lockable manner into a connector-terminal socket originally intended to insertingly receive the connector terminal.

### BACKGROUND ART

Heretofore, in an intercommunication system, a transmission cable has been used for transmitting and receiving various signals. This transmission cable is connected to a connector-terminal socket of a communication or communication-relay apparatus using one of connector terminals attached to respective opposite ends of the transmission cable. In connection with diversification in communication means/systems and increase in communication volume, some communication or communication-relay apparatuses have a large number of connector-terminal sockets.

In a communication network, for example, LAN (Local Area Network) based on TCP/IP (Transmission Control Protocol/Internet Protocol), a hub connectable with a large number of connector terminals of LAN cables is used for interconnecting a plurality of computers serving as communication terminal units.

From a practical standpoint, it is a rare case that all of the connector-terminal sockets of the hub are in connected relation with LAN-cable connector terminals. Further, in conjunction of installation of new computers, relocation of existing computers, network reconstruction, etc., LAN-cable connector terminals are often disconnected and re-connected from/to the hub. This operation involves a problem that a connector terminal is erroneously inserted into an improper or unauthorized connector-terminal socket which has no connector terminal connected thereto, to cause a failure of the communication network.

The connection of LAN cables in a communication network is typically managed by a network administrator. In some cases, the operation for connecting LAN-cable connectors to the hub is performed by a plurality of network administrators or a network administrator and assistant staffs, for various reasons. This operation involves a problem that a connector terminal is erroneously inserted into an unauthorized connector-terminal socket to cause a failure of the communication network, due to the lack of means for distinguishing between authorized connector-terminal sockets and unauthorized connector-terminal sockets on an administrator-by-administrator basis.

### DISCLOSURE OF THE INVENTION

In view of the above circumstances, it is an primary object of the present invention to provide a dummy terminal capable of being inserted in a lockable manner into a connector-terminal socket, instead of a cable connector terminal, so as to prevent a cable connector terminal from being erroneously inserted into an improper or unauthorized connector-terminal socket which has no cable connector terminal connected thereto.

It is an another object of the present invention to provide a dummy terminal capable of being inserted in a lockable manner into a connector-terminal socket, instead of a cable connector terminal, while allowing each network administrator to distinguish whether or not the connector-terminal socket is an authorized connector-terminal socket.

In order to solve the above problems and achieve the above objects, as set forth in the appended claim 1, according to a first aspect of the present invention, there is provided a dummy terminal designed to be inserted into a connector-terminal socket originally intended to insertingly receive a connector terminal attached to an end of a signal transmission cable. This dummy terminal comprises a dummy terminal body adapted to be inserted into the connector-terminal socket, dummy-terminal engagement means mounted on the dummy terminal body and adapted to be engaged with a connector-terminal latching portion formed in the connector-terminal socket, and dummy-terminal lock means including a lock member which is mounted on the dummy terminal body and adapted to allow the dummy terminal body after being inserted into the connector-terminal socket, to be locked in its engaged state through the dummy-terminal engagement means.

In order to solve the above problems and achieve the above objects, as set forth in the appended claim 2, in the first aspect of the present invention, the dummy-terminal engagement means includes a flexible engagement member having an engagement portion adapted to be engaged with the connector-terminal latching portion.

In order to solve the above problems and achieve the above objects, as set forth in the appended claim 3, in the first aspect of the present invention, the dummy-terminal lock means further includes a screw hole formed in the dummy terminal body, and a set screw threadingly engageable with the screw hole in a detachable manner. The set screw is adapted to be tightened so as to allow the dummy terminal body to be locked in the engaged state, and to be loosened so as to allow the dummy terminal body to be released from the lock-in state.

In order to solve the above problems and achieve the above objects, as set forth in the appended claim 4, in the first aspect of the present invention, the lock member of the dummy-terminal lock means is swingably mounted on the dummy terminal body.

In order to solve the above problems and achieve the above objects, as set forth in the appended claim 5, according to a second aspect of the present invention, there is provided a dummy terminal designed to be inserted into a connector-terminal socket originally intended to insertingly receive a connector terminal attached to an end of a signal transmission cable. This dummy terminal comprises a dummy terminal body adapted to be inserted into the connector-terminal socket, and dummy-terminal release means. The dummy terminal body has a base, an upstanding segment extending upward from the base, an engagement segment which extends approximately parallel to the base, and has a distal end formed as an engagement portion adapted to be engaged with and latched by a connector-terminal latching portion formed in the connector-terminal socket and a proximal end connected to the upstanding segment. The dummy-terminal release means is adapted to release a latched state of the dummy terminal body after being inserted into the connector-terminal socket.

In order to solve the above problems and achieve the above objects, as set forth in the appended claim 6, in the second aspect of the present invention, the dummy-terminal release means includes a screw hole formed in the dummy terminal body, and a set screw threadingly engageable with the screw hole in a detachable manner. The set screw is adapted to be loosened so as to allow the dummy terminal body to be placed in the latched state, and to be tightened so as to allow the dummy terminal body to be released from the latched state.

In order to solve the above problems and achieve the above objects, as set forth in the appended claim 7, according to a third aspect of the present invention, there is provided a dummy terminal designed to be inserted into a connector-terminal socket originally intended to insertingly receive a connector terminal attached to an end of a signal transmission cable. This dummy terminal comprises a dummy terminal body adapted to be inserted into the connector-terminal socket, and dummy-terminal lock means mounted on the dummy terminal body. The dummy terminal body has a base, an upstanding segment extending upward from the base, an engagement segment which extends approximately parallel to the base, and has a distal end formed as an engagement portion adapted to be engaged with a connector-terminal latching portion formed in the connector-terminal socket and a proximal end connected to the upstanding segment. The dummy-terminal lock means is adapted to allow the dummy-terminal body after being inserted into the connector-terminal socket, to be locked in its engaged state through the engagement portion.

In order to solve the above problems and achieve the above objects, as set forth in the appended claim 8, in the third aspect of the present invention, the dummy-terminal lock means includes a screw hole formed in the dummy terminal body, and a set screw threadingly engageable with the screw hole in a detachable manner. The set screw is adapted to be tightened so as to allow the dummy terminal body to be locked in the engaged state, and to be loosened so as to allow the dummy terminal body to be released from the lock-in state.

In order to solve the above problems and achieve the above objects, as set forth in the appended claim 9, the dummy terminal in either one of the first to third aspects of the present invention includes discrimination means for discriminating between a plurality of connector-terminal socket.

In order to solve the above problems and achieve the above objects, as set forth in the appended claim 10, the discrimination means includes at least one selected from the group consisting of a color sticker, a special screw and a coloring material.

### BRIEF DESCRIPTION OF DRAWINGS

FIG. 1 is a perspective view showing a dummy terminal 10 according to a first embodiment of the present invention.

FIGS. 2A to 2C are detail views showing a dummy terminal body 12 and an engagement member 14 fixedly mounted on the dummy terminal body 12 in the first embodiment.

FIGS. 3A and 3B are detail views showing the dummy terminal body 12 and the engagement member 14 fixedly mounted on the dummy terminal body 12 in the first embodiment.

FIGS. 4A and 4B are detail views showing a thin plate member 13 in the first embodiment.

FIG. 5 is a perspective view showing a plurality of connector-terminal sockets 104 of a hub 101 for insertingly receiving a dummy terminal 10 of the present invention.

FIG. 6 is an explanatory diagram showing a state before the dummy terminal 10 according to the first embodiment is inserted into one of the connector-terminal sockets 104 of the hub 101.

FIG. 7 is an explanatory diagram showing a state after the dummy terminal 10 according to the first embodiment is inserted into the connector-terminal socket 104, and locked in its engaged state.

FIGS. 8A to 8C are explanatory diagrams showing various types of special screws.

FIG. 9 is a perspective view showing a dummy terminal 10 according a second embodiment of the present invention.

FIG. 10 is a top plan view showing the dummy terminal 10 according the second embodiment.

FIG. 11 is a side view showing the dummy terminal 10 according the second embodiment.

FIG. 12 is a front view showing the dummy terminal 10 according the second embodiment.

FIG. 13A is a perspective view showing a dummy terminal 10 according a third embodiment of the present invention.

FIG. 13B is a partially sectional view showing a state after the dummy terminal 10 according the third embodiment is inserted into the connector-terminal socket 104.

FIGS. 14A and 14B are, respectively, a side view and a top plan view showing a dummy terminal body 12 in the dummy terminal 10 according the third embodiment.

FIG. 15A is a perspective view showing a dummy terminal 10 according a fourth embodiment of the present invention.

FIG. 15B is a partially sectional view showing a state after the dummy terminal 10 according the fourth embodiment is inserted into the connector-terminal socket 104.

FIGS. 16A and 16B are, respectively, a side view and a top plan view showing a dummy terminal body 12 in the dummy terminal 10 according the fourth embodiment.

FIG. 17 is an explanatory perspective view showing one example of means for discriminating between a plurality of connector-terminal sockets, based on the dummy terminal 10 according to the first embodiment.

FIG. 18 is an explanatory perspective view showing another example of the means for discriminating between a plurality of connector-terminal sockets, based on the dummy terminal 10 according to the second embodiment.

FIG. 19 is an explanatory perspective view showing another example of the means for discriminating between a plurality of connector-terminal sockets, based on the dummy terminal 10 according to the third embodiment.

FIG. 20 is an explanatory perspective view showing another example of the means for discriminating between a plurality of connector-terminal sockets, based on the dummy terminal 10 according to the fourth embodiment.

### BEST MODE FOR CARRYING OUT THE INVENTION

With reference to the drawings, a dummy terminal according to an embodiment of the present invention will now be specifically described.

### First Embodiment

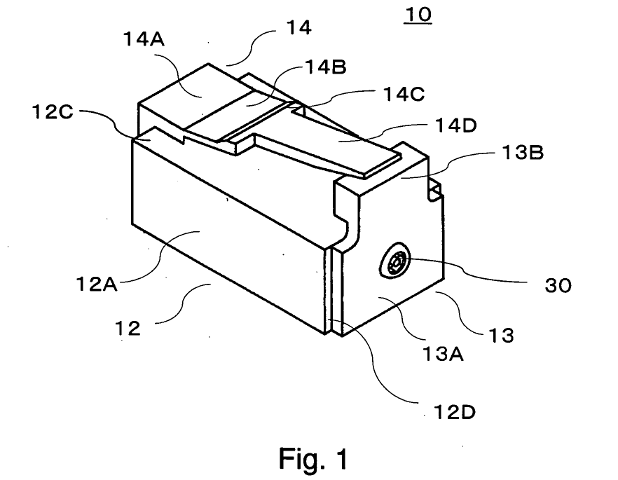

With reference to FIGS. 1 to 8C, a first embodiment of the present invention will be described below.

FIG. 1 is a perspective view showing a dummy terminal 10 according to a first embodiment of the present invention. The dummy terminal 10 comprises a dummy terminal body 12, a thin plate member 13, an engagement member 14 and a set screw 30. The dummy terminal body 12 is generally composed of a grooved frame defined by opposite side walls 12A, 12B and top wall 12C, and a front wall 12D formed at a front end of the grooved frame. This dummy terminal body 12 is formed to have approximately same size as that of an insertion portion of a target connector-terminal socket. The thin plate member 13 is generally composed of an anchor portion 13A to be mounted on the front wall 12D, and a restraint portion 13B for placing an engaged state of the engagement member 14 under restraint. The engagement member 14 is mounted on the rear end of the grooved frame of the dummy terminal body 12. The engagement member 14 has an anchor portion 14A fixedly mounted on the dummy terminal body 12, a deformable or flexible portion 14B, an engagement portion 14C and an engagement release portion 14D.

In the engagement member 14, the flexible portion 14B is formed to have a relatively large width, and the engagement release portion 14D continuous with the flexible portion 14B is formed to have a width less than that of the flexible portion 14B. That is, the engagement member 14 is formed with a pair of steps extending in a width direction at approximately the longitudinal center thereof, and the steps serves as the engagement portion 14C adapted to be engaged with a connector-terminal latching portion formed in the connector-terminal socket.

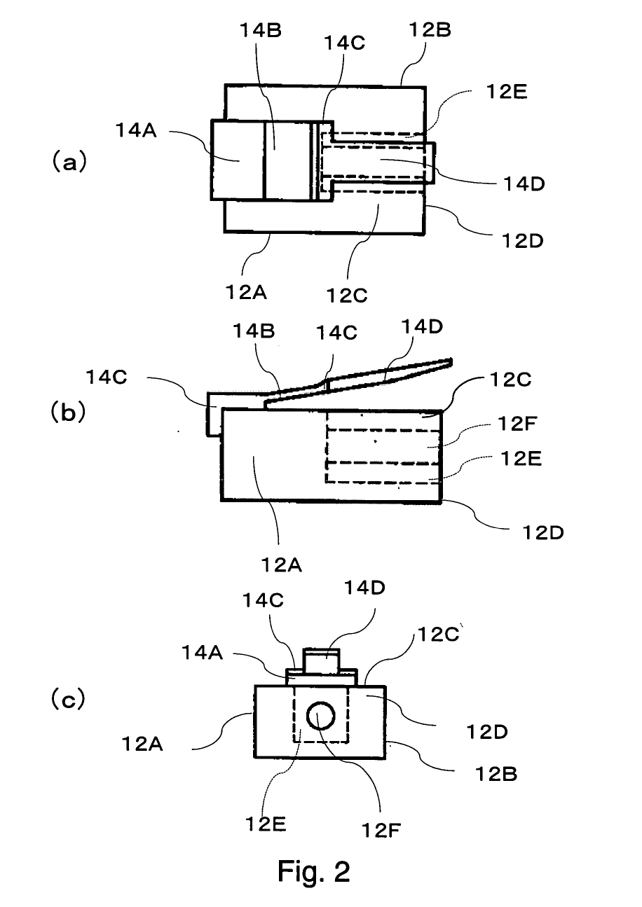

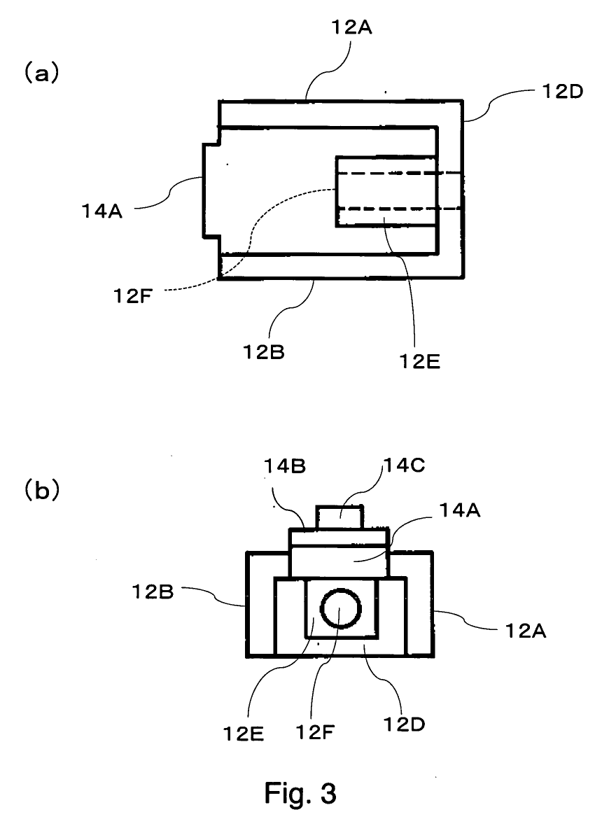

FIGS. 2A to 2C and FIGS. 3A and 3B are detail views showing the dummy terminal body 12 and the engagement member 14 fixedly mounted on the dummy terminal body 12. FIGS. 2A, 2B and 2C are, respectively, is a top plan view when viewed from the side of the top wall 12C of the dummy terminal body 12, a side view when viewed from the side of the side wall 12A of the dummy terminal body 12, and a front view when viewed from the side of the front wall 12D formed at the front end of the grooved frame defined by the side walls 12A, 12B and the top wall 12C of the dummy terminal body 12. FIGS. 3A and 3B are, respectively, a bottom view when viewed from the side of a bottom opening of the grooved frame defined by the side walls 12A, 12B and the top wall 12C of the dummy terminal body 12, and a rear view when viewed from the side of the rear end of the grooved frame.

Further, the dummy terminal body 12 has a screw-hole defining portion 12E formed to extend from an inner surface of the front wall 12D toward an inner space of the grooved frame defined by the side walls 12A, 12B and the top wall 12C of the dummy terminal body 12. A screw hole 12F for threadingly receiving the set screw 30 is formed in the front wall 12D and the screw-hole defining portion 12E in a direction perpendicular to the front wall 12D.

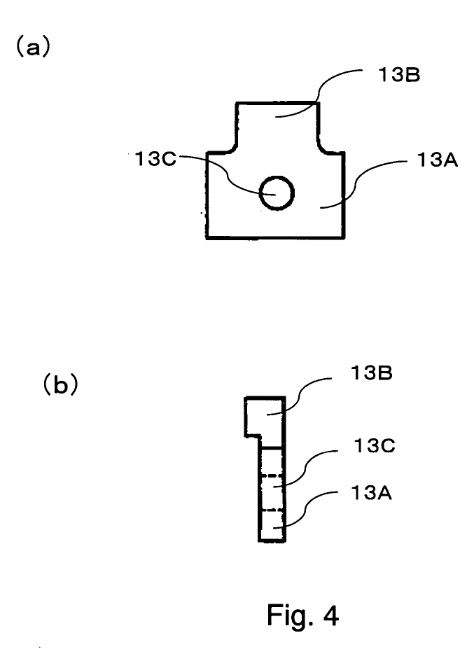

FIGS. 4A and 4B are, respectively, a front view and a side view showing the detail of the thin plate member 13.

The thin plate member 13 is formed with a loose hole at approximately the center of the anchor portion 13A. The restraint portion 13B is formed to have a thickness greater than that of the anchor portion 13A so as to reliably place the engaged state of the engagement member 14 under restraint.

Each of the dummy terminal body 12, the thin plate member 13 and the engagement member 14 is primarily made of a synthetic resin having insulating performance and elasticity in addition to excellent formability and cost performance, such as ABS (acrylonitrile-butadiene-styrene) resin or PC (polycarbonate) resin.

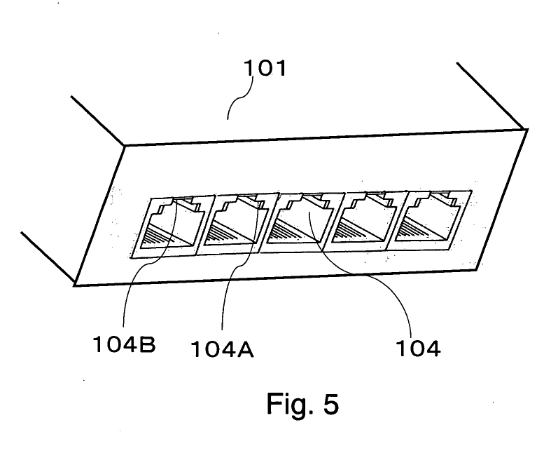

With reference to FIGS. 5 to 7, an operation for inserting the dummy terminal 10 into a connector-termninal socket of a hub 101, and locking in an engaged state of the dummy terminal 10 will be described below.

A dummy terminal 10 of the present invention is designed to be inserted into one of a plurality of connector-terminal sockets of a hub 101 originally intended to be connected with a large number of connector terminals of LAN cables so as to interconnect a plurality of computers serving as communication terminal units, and engaged with the connector-terminal socket in such a manner that the engaged state is selectively locked or unlocked.

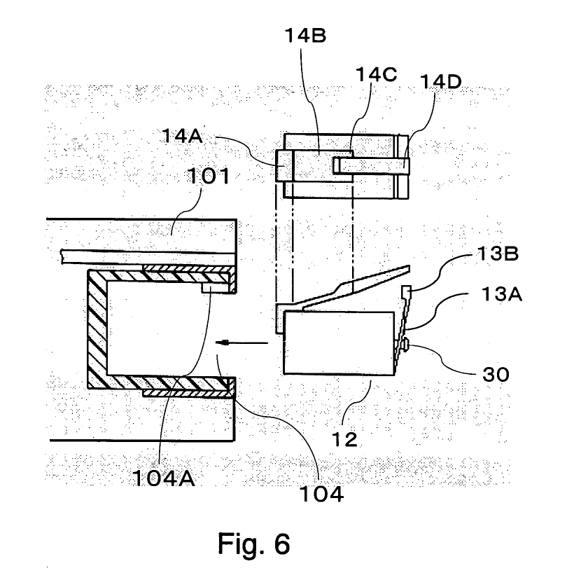

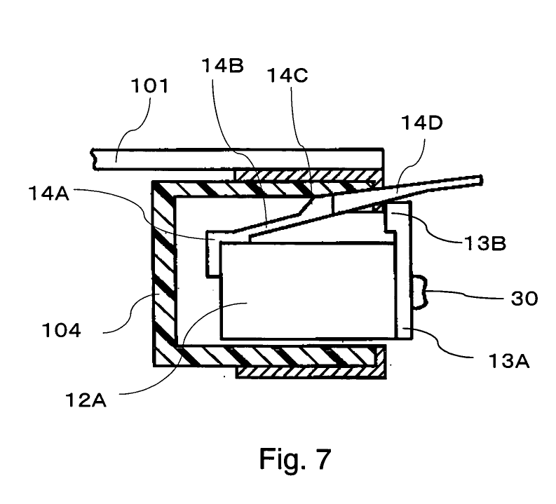

FIG. 5 is a perspective view showing the plurality of connector-terminal sockets 104 of the hub 101 for insertingly receiving the dummy terminal 10 of the present invention. FIG. 6 shows a state before the dummy terminal 10 according to the first embodiment is inserted into one of the connector-terminal sockets 104 of the hub 101, and FIG. 7 shows a state after the dummy terminal 10 according to the first embodiment is inserted into the connector-terminal socket 104, and locked in its engaged state.

As shown in FIG. 5, each of the plurality of connector-terminal sockets 104 has a first groove 104A formed to extend rearward from an upper region of an opening thereof and have a width which allows the wide flexible portion 14B of the engagement member 14 to be inserted therealong, and a second groove 104B formed to extend from the opening along an inner top surface thereof and have a width which precludes the wide flexible portion 14B of the engagement member 14 from being inserted thereinto and allows only the narrow engagement release portion 14D to be inserted therealong. The connector-terminal latching portion is defined by a step between the first groove 104A and the second groove 104B. Specifically, the first groove 104A is formed to have a relatively short length in an insertion direction of the dummy terminal 10. Thus, when the dummy terminal 10 is fully inserted into the connector-terminal socket, the engagement portion 14C falls in the connector-terminal latching portion defined by the step vertically extending between the first groove 104A and the second groove 104B, according to an elastic force of the flexible portion 14B, so that the dummy terminal body 12 is engaged with the connector-terminal latching portion.

With reference to FIGS. 6 and 7, the operation for inserting the dummy terminal 10 into the connector-terminal socket 104 of the hub 101, and locking in the engaged state will be described in more detail below. In FIG. 6, the set screw 30 is loosened. Thus, the thin plate member 13 is not tightly mounted on the dummy terminal body 12, and thereby the engagement member 14 is not in a restrained state. In this state, when the dummy terminal 10 is inserted into the connector-terminal socket 104 from the side of the anchor portion 14A of the engagement member 14, the flexible portion 14B of the engagement member 14 is inserted along the first groove 104A while elastically deforming.

Along with the insertion of the dummy terminal 10, the flexible portion 14B of the engagement member 14 will be gradually pushed down by an inner top surface of the first groove 104A while passing through the first groove 104A. Then, just after reaching the aforementioned connector-terminal latching portion, the engagement portion 14C falls and enters in the narrow second groove 104B according to the elastic force of the flexible portion 14B, and engaged with the connector-terminal latching portion. Thus, the width-directional steps between the flexible portion 14B and the engagement release portion 14D are engaged with the vertical step between the first groove 104A and the second groove 104B, to allow the dummy terminal 10 inserted into the connector-terminal socket 104 to be placed in an engaged state.

After the dummy terminal 10 inserted into the connector-terminal socket 104 is placed in the engaged state, the set screw 30 is driven into the screw hole or tightened. As mentioned above, the thin plate member 13 is formed with the loose hole 13C for allowing the set screw 30 to loosely penetrate therethrough. Through the operation of tightening the set screw 30, the anchor portion 13A of the thin plate member 13 is fixedly mounted on the front wall 12D of the dummy terminal body 12. The fixed anchor portion 13A allows the restraint portion 13B to restrain movement of the engagement release portion 14D of the engagement member 14. Thus, shown in FIG. 7, the dummy terminal 10 inserted into the connector-terminal socket 104 is maintained (or locked) in the engaged state. In this way, the dummy terminal of the present invention can be inserted into a connector-terminal socket which is not connected with any connector terminal but banned from being used, and placed in a latched state in advance, so as to prevent an improper connector terminal from being erroneously inserted thereinto.

In an operation for pulling out the dummy terminal 10 inserted and placed in the latched state, the set screw 30 is firstly loosened to release the fixed state of the anchor portion 13A of the thin plate member 13 and allow the engagement release portion 14D restrained in movement by the restraint portion 13B to be movable. Then, the engagement release portion 14D is pressed down against its own elastic force. Through this downward pressing, the width-directional steps between the flexible portion 14B and the engagement release portion 14D are disengaged from the vertical step between the first groove 104A and the second groove 104B, to allow the dummy terminal 10 to be pulled out of the connector-terminal socket 104.

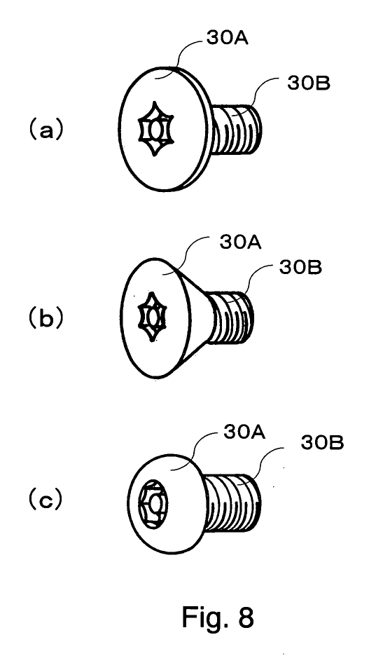

While the type of the set screw 30 is not specified in the first embodiment, a normal screw may be used or a special screw as shown in FIG. 8 may be used.

Even if the dummy terminal 10 is simply inserted into a connector-terminal socket, an effect of preventing an accidental trouble otherwise caused by erroneously inserting an improper connector terminal can be obtained. However, if the set screw 30 is a normal type, it can be readily loosened. Thus, the dummy terminal 10 using a normal screw is not effective against a trouble caused by erroneously pulling out the dummy terminal 10 from a connector-terminal socket and inserting an improper connector terminal into the connector-terminal socket.

FIGS. 8A to 8C show some examples of a special screw usable as the set screw 30. The set screw 30 comprises a screw head 30A and a threaded shank 30B. FIGS. 8A, 8B and 8C show respective examples of an ultrathin flathead screw, a countersunk tamper-proof screw and a round tamper-proof screw. Each of these set screws has a screw head 30A for use in tightening and loosening the screw. The screw head 30A is formed with a special 3-dimensional dent, and can be driven using a single-purpose tool to detach the set screw 30.

The special screws as shown in FIGS. 8A to 8C used as the set screw 30 make it possible to provide self-distinctiveness to the dummy terminals of the present invention, so as to allow each network administrator to distinguish between a proper or authorized connector-terminal socket and an improper or unauthorized connector-terminal socket. Specifically, the special screws as shown in FIGS. 8A to 8C are required to use single-purpose tools for tightening/loosening them. Thus, for example, the special screw illustrated in FIG. 8A is used as the set screw 30 of the dummy terminal for a specific connector-terminal socket to be used by a specific network administrator, and a single-purpose tool necessary for tightening/loosening the special screw illustrated in FIG. 8A is managed such that it can be used only by the specific network administrator. This makes it possible to allow only by the specific network administrator to use the specific connector-terminal socket. Thus, a special screw used as the set screw 30 can prevent occurrence of a trouble caused by erroneously pulling out the dummy terminal 10 from a connector-terminal socket.

<Example of Modification>

While the first embodiment has been described such that the set screw 30 is loosened during the operation for inserting the dummy terminal 10 into the connector-terminal socket 104, the present invention is not limited to this manner. For example, the set screw 30 is firstly tightened to fixedly mount the anchor portion 13A on the front wall 12D so as to restrain movement of the engagement release portion 14D of the engagement member 14, and then the dummy terminal 10 set as shown in FIG. 7 may be inserted into the connector-terminal socket 104. This operation can be performed, because, even if the engagement member 14 is in the restrained state, the flexible portion 14B of the engagement member 14 is pushed rearward while elastically deforming, along with insertion of the dummy connector 10 into the connector-terminal socket 104, and finally reaches the connector-terminal latching portion. In this case, the dummy terminal 10 having the set screw 30 in the tightened state can be inserted into the connector-terminal socket 104. Thus, a plurality of the dummy terminals pre-set as above can be successively inserted one-by-one into a plurality of connector-terminal sockets banned from being used, so as to effectively prevent erroneous connection of connector terminals.

### Second Embodiment

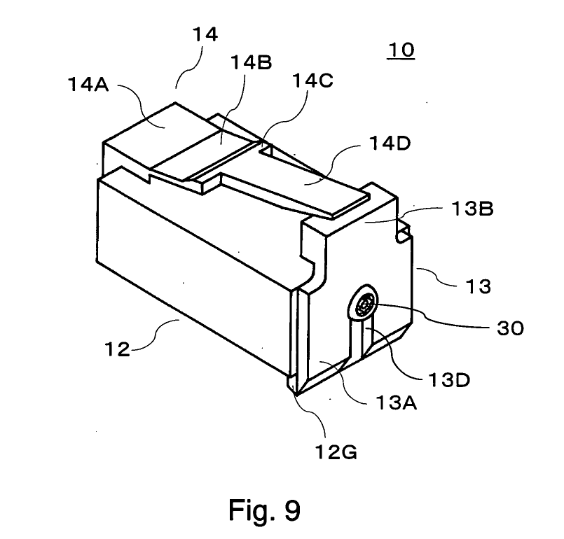

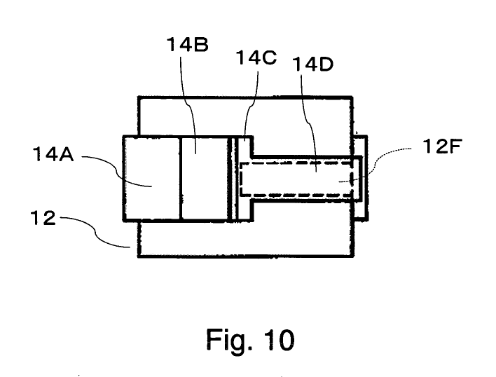

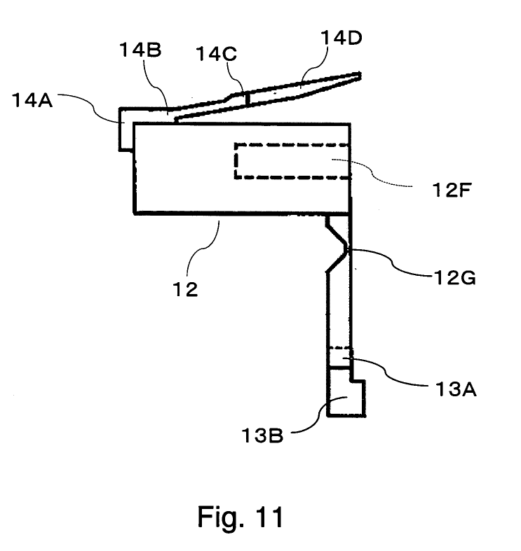

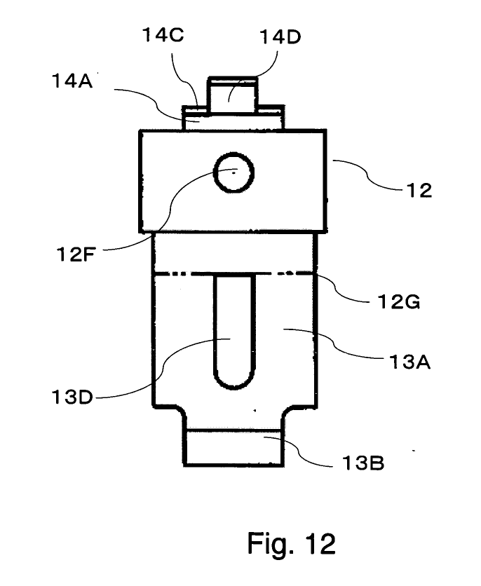

With reference to FIGS. 9 to 12, a second embodiment of the present invention will be described below. FIG. 9 is a perspective view showing a dummy terminal 10 according the second embodiment. FIGS. 10, 11 and 12 are, respectively, a top plan view, a side view and a front view showing the dummy terminal 10 according the second embodiment.

The dummy terminal 10 comprises an approximately rectangular parallelepiped-shaped dummy terminal body 12, a thin plate member 13, an engagement member 14 and a set screw 30. The dummy terminal body 12 is formed to have approximately same size as that of an insertion portion of a target connector-terminal socket. The thin plate member 13 is swingably fixed to or formed with a front lower edge of the dummy terminal body 12, and the engagement member 14 is fixedly mounted on a rear upper edge of the dummy terminal body 12. The dummy terminal body 12 has a screw hole 12F for threadingly receiving the set screw 30. The screw hole 12F extends from a front surface of the dummy terminal body 12 in a direction perpendicular to the front surface.

The thin plate 13 is generally composed of a pivotal portion 12G fixed to or formed with the front lower edge of the dummy terminal body 12, an anchor portion 13A adapted to be swung about the pivotal portion 12G and brought into contact with the front surface of the dummy terminal body 12, and a restraint portion 13B for placing an engaged state of the engagement member 14 under restraint. A cutout 13D for allowing the set screw to penetrate therethrough is formed in an approximately laterally central region of the anchor portion 13A. The cutout 13D extends parallel to a direction from the pivotal portion 12G toward the restraint portion 13B. When the set screw 30 is loosened but not detached, the cutout 13D allows the thin plate member 13 to be swung at an angle corresponding to the level of loosening of the set screw 30.

The engagement member 14 is mounted on the rear upper edge of the dummy terminal body 12. The engagement member 14 has an anchor portion 14A fixedly mounted on the dummy terminal body 12, a deformable or flexible portion 14B, an engagement portion 14C and an engagement release portion 14D. In the engagement member 14, the flexible portion 14B is formed to have a relatively large width, and the engagement release portion 14D continuous with the flexible portion 14B is formed to have a width less than that of the flexible portion 14B. That is, the engagement member 14 is formed with a pair of steps extending in a width direction at approximately the longitudinal center thereof, and the steps serves as the engagement portion 14C adapted to be engaged with the connector-terminal latching portion formed in the connector-terminal socket.

In an operation for inserting the dummy terminal 10 according to the second embodiment into a connector-terminal socket of a hub 101, and locking in an engaged state of the dummy terminal 10, the set screw 30 illustrated in FIG. 9 is firstly loosened to prevent the restraint portion from restraining movement of the engagement release portion 14D. In this state, the dummy terminal 10 is inserted into the connector-terminal socket. Along with the insertion of the dummy terminal 10 into the connector-terminal socket, the flexible portion 14B of the engagement member 14 will be pushed rearward while elastically deforming, and the engagement portion 14C is engaged with a connector-terminal latching portion formed in the connector-terminal socket. Then, when the set screw 30 is tightened after the dummy terminal 10 is inserted into the connector-terminal socket 104 and placed in the engaged state, the anchor portion 13A of the thin plate member 13 is brought in contact with the front surface of the dummy terminal body 12 and fixedly mounted thereon. The fixed anchor portion 13A allows the restraint portion 13B to restrain movement of the engagement release portion 14D of the engagement member 14. Thus, the dummy terminal 10 inserted into the connector-terminal socket 104 is maintained (or locked) in the engaged state. In this way, the dummy terminal of the present invention can be inserted into a connector-terminal socket which is not connected with any connector terminal but banned from being used, and placed in a latched state in advance, so as to prevent an improper connector terminal from being erroneously inserted thereinto.

In an operation for pulling out the dummy terminal 10 inserted and placed in the latched state, the set screw 30 is firstly loosened to release the fixed state of the anchor portion 13A of the thin plate member 13 and allow the engagement release portion 14D restrained in movement by the restraint portion 13B to be movable. Then, the engagement release portion 14D is pressed down against its own elastic force. Through this downward pressing, the dummy terminal 10 can be released from the engaged state, and pulled out of the connector-terminal socket 104.

Each of the dummy terminal body 12, the thin plate member 13 and the engagement member 14 is primarily made of a synthetic resin having insulating performance and elasticity in addition to excellent formability and cost performance, such as ABS (acrylonitrile-butadiene-styrene) resin or PC (polycarbonate) resin.

### Third Embodiment

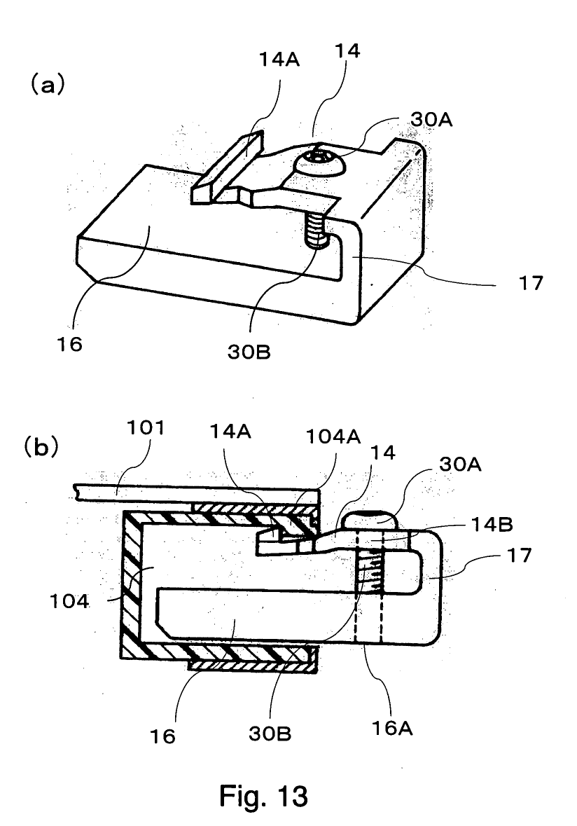

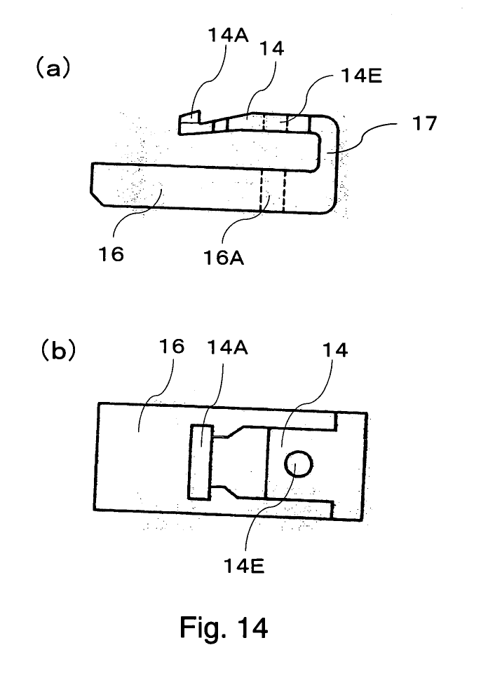

With reference to FIGS. 13A to 14B, a third embodiment of the present invention will be described.

FIG. 13A is a perspective view showing a dummy terminal 10 according the third embodiment, and FIG. 13B is a partially sectional view showing a state after the dummy terminal 10 is inserted into a connector-terminal socket. FIGS. 14A and 14B are, respectively, a side view and a top plan view showing a dummy terminal body 12 in the dummy terminal 10 according the third embodiment.

The dummy terminal 10 according the third embodiment comprises a dummy terminal body 12, and a set screw 30. The dummy terminal body 12 has an approximately rectangular parallelepiped-shaped base 16 adapted to be inserted into a connector-terminal socket, a standing member 17 formed at one end of the base 16 on the opposite side of the other end to be firstly inserted into a connector-terminal socket, and an engagement member 14 which extends approximate Ely parallel to the base, and has a distal end formed as an engagement portion 14A adapted to be engaged with a connector-terminal latching portion of a target connector-terminal socket, and a proximal end connected to the standing member 17. This dummy terminal body 12 is formed to have approximately same size as that of an insertion portion of the connector-terminal socket. The base 16, the standing member 17, the engagement member 14 are integrally formed in a single piece.

The base 16 is formed with a screw hole 16 threadingly engageable with the set screw 30, and the engagement member 14 is formed with a loose hole 30 for allowing the set screw 30 to loosely penetrate therethrough. The engagement member 14 is formed to allow a distance between the distal end and the base 16 to become greater than a distance between a distance between the proximal end and the base 16. As described in connection with the first and second embodiments, the dummy terminal body 12 having the base 16, the engagement member 14 and the standing member 17 is primarily made of a synthetic resin having insulating performance and elasticity in addition to excellent formability and cost performance.

An operation for inserting the dummy terminal 10 according to the third embodiment into a connector-terminal socket of a hub 101 and locking in a latched state of the dummy terminal 10 will be described below.

As mentioned above, the dummy terminal 10 of the present invention is designed to be inserted into one of a plurality of connector-terminal sockets of a hub 101 originally intended to be connected with a large number of connector terminals of LAN cables so as to interconnect a plurality of computers serving as communication terminal units, and engaged with the connector-terminal socket in such a manner that the engaged state is selectively locked or unlocked.

The hub 101 illustrated in FIG. 13B has the same structure as that illustrated in FIG. 5. Specifically, each of the plurality of connector-terminal sockets 104 has the first groove 104A and the second groove 104B, and the connector-terminal latching portion is defined by the step between the first groove 104A and the second groove 104B. When the dummy terminal 10 is inserted into the connector-terminal socket, the engagement member 14 is inserted along the first groove 104A while elastically deforming, and the engagement portion is engaged with the connector-terminal latching portion in a latched state. The dummy terminal 10 according to the third embodiment has no engagement release member, and thereby the latched state is hardly released. Thus, the dummy terminal 10 according to the third embodiment can be simply inserted into a connector-terminal socket which is not connected with any connector terminal but banned from being used, so as to prevent an improper connector terminal from being erroneously inserted thereinto.

In an operation for pulling out the dummy terminal 10 according to the third embodiment, the set screw 30 is loosened to allow the engagement member 14 to be deformed toward the base 16 against elasticity of the engagement member 14 and the standing member 17, so as to release the engaged and latched state between the engagement portion 14A and the connector-terminal latching portion.

<Example of Modification>

While the first embodiment has been described such that the screw hole 16A threadingly engageable with the set screw 30 is formed in the base 16, the present invention is not limited to such a structure, but the engagement member 14 may be formed with a screw hole. When the screw hole 16A is formed in the engagement member 14, the engagement member 14 is formed to allow a distance between the distal end and the base 16 to become approximately equal to a distance between a distance between the proximal end and the base 16. In this modification, when the set screw 30 is tightened, the engagement member 14 is deformed upward or in a direction getting away from the base 16 to allow an engaged state between the engagement portion 14A and the connector-terminal latching portion to be placed in a latched state. This latched state may be released by loosening the set screw 30. In this structure, there is no need for forming a loose hole in the base 16.

### Fourth Embodiment

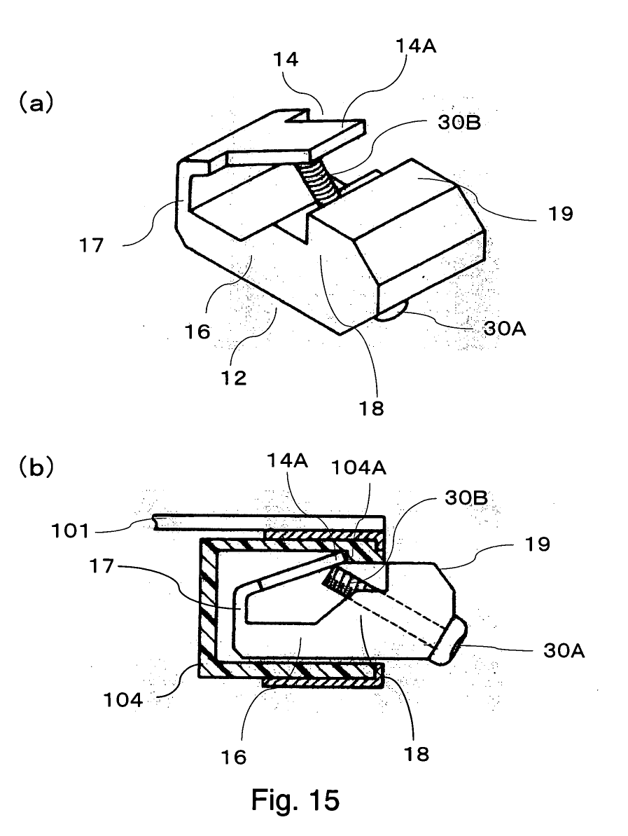

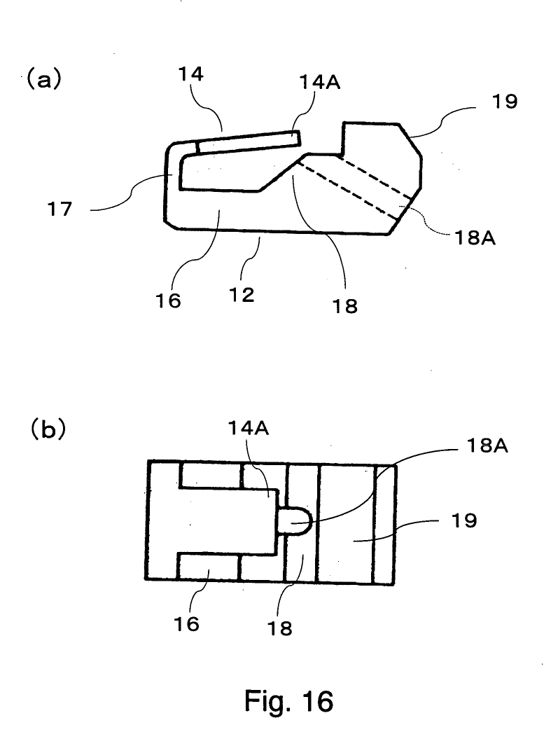

With reference to FIGS. 15A to 16B, a fourth embodiment of the present invention will be described. FIG. 15A is a perspective view showing a dummy terminal 10 according the fourth embodiment, and FIG. 15B is a partially sectional view showing a state after the dummy terminal 10 is inserted into a connector-terminal socket. FIGS. 16A and 16B are, respectively, a side view and a top plan view showing a dummy terminal body 12 in the dummy terminal 10 according the fourth embodiment.

The dummy terminal 10 according the fourth embodiment comprises a dummy terminal body 12, and a set screw 30. The dummy terminal body 12 has a base 16 adapted to be inserted into a terminal-connector socket, a standing member 17 formed at one end of the base 16 on the opposite side of the other end to be firstly inserted into the connector-terminal socket, an engagement member 14 which extends approximately parallel to the base 16 and has a distal end formed as an engagement portion 14A adapted to be engaged with a connector-terminal latching portion of a target connector-terminal socket, and a proximal end connected to the standing member 17, and a grip member 19 which has a screw-hole defining portion 18 integrated with the base 16 and formed with a screw hole 18A for the set screw 30, and a grip portion 19 for allowing an operator or user to grip it in an operation of inserting and detaching the dummy terminal body 12 into/from the connector-terminal socket. This dummy terminal body 12 is formed to have approximately same size as that of an insertion portion of the connector-terminal socket. The base 16, the standing member 17, the engagement member 14 are integrally formed in a single piece.

The engagement member 14 is formed to allow a distance between the distal end and the base 16 to become greater than a distance between a distance between the proximal end and the base 16. The screw hole 18A in the screw-hole defining portion 18 is formed to have a given angle with an insertion direction in which the base 16 is inserted into the connector-terminal socket, so as to allow a top of the set screw 30 to be brought into contact with the engagement member 14 when the set screw 30 is threadingly driven into the screw hole 18A or tightened. As described in connection with the first to third embodiments, the dummy terminal body 12 having the base 16, the engagement member 14, the standing member 17 and grip member 19 is primarily made of a synthetic resin having insulating performance and elasticity in addition to excellent formability and cost performance.

An operation for inserting the dummy terminal 10 according to the fourth embodiment into a connector-terminal socket of a hub 101 and locking in a latched state of the dummy terminal 10 will be described below.

As mentioned above, the dummy terminal 10 of the present invention is designed to be inserted into one of a plurality of connector-terminal sockets of a hub 101 originally intended to be connected with a large number of connector terminals of LAN cables so as to interconnect a plurality of computers serving as communication terminal units, and engaged with the connector-terminal socket in such a manner that the engaged state is selectively locked or unlocked.

The hub 101 illustrated in FIG. 14B has the same structure as that illustrated in FIG. 5. Specifically, each of the plurality of connector-terminal sockets 104 has the first groove 104A and the second groove 104B, and the connector-terminal latching portion is defined by the step between the first groove 104A and the second groove 104B. When the dummy terminal 10 according to the fourth embodiment is inserted into the connector-terminal socket, and the set screw 30 is tightened, the engagement member 14 is deformed by the top of the set screw 30 toward the connector-terminal latching portion against elasticity of the standing member 17, to allow the engagement portion 14A to be fixedly engaged with the connector-terminal latching portion and placed in a latched state. This latched state can prevent an improper connector terminal from being erroneously inserted into the connector-terminal socket.

In the dummy terminal 10 according to the fourth embodiment, when the set screw 30 is loosened, the engagement portion 14A is returned to it original position approximately parallel to the base 16 according to elasticity of the engagement member 14 and the standing member 17, so as to release the engaged and latched state between the engagement portion 14A and the connector-terminal latching portion. After the release of the latched state, the dummy terminal 10 can be pulled out of the connector-terminal socket.

### Fifth Embodiment

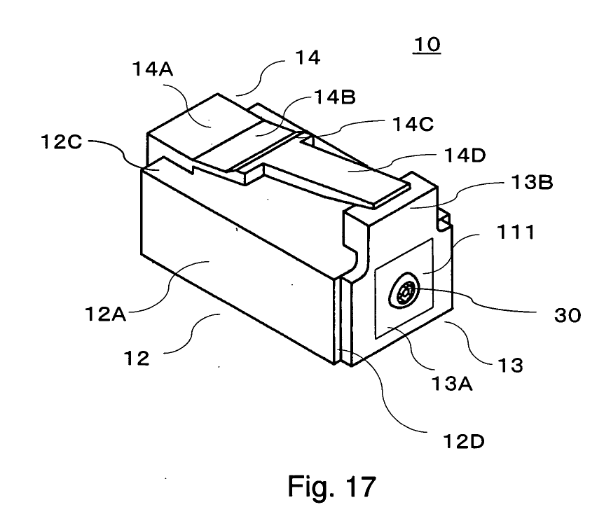

With reference to FIG. 17 to 20, a fifth embodiment of the present invention will specifically be described.

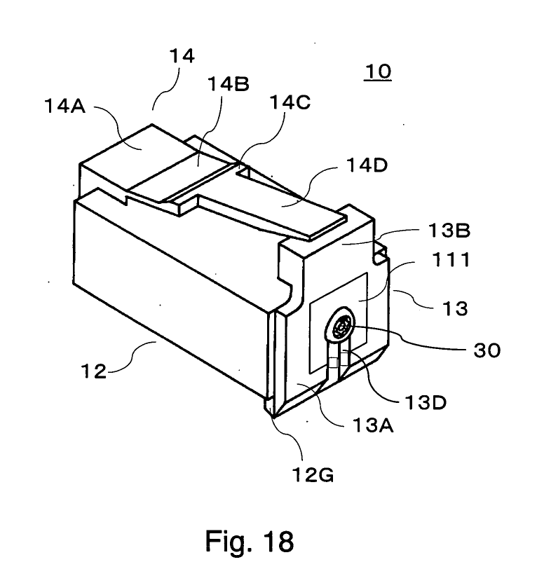

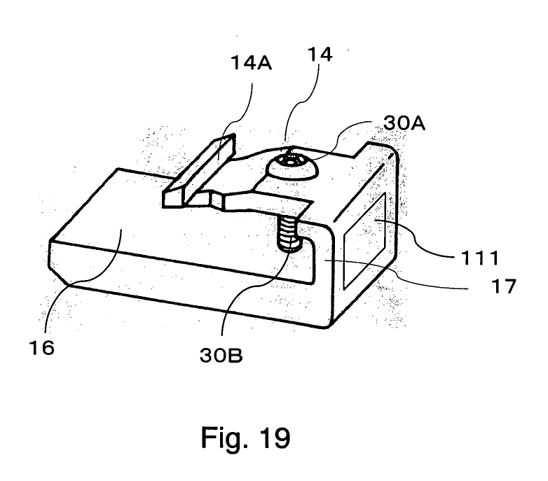

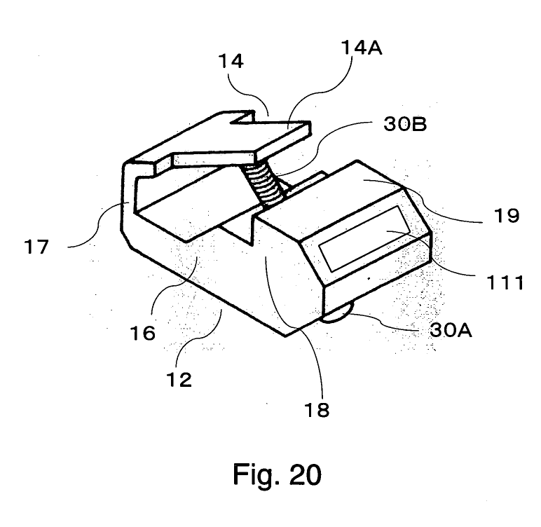

A dummy terminal 10 according to the fifth embodiment has means for discriminating between a plurality of connector-terminal sockets. FIG. 17 is an explanatory perspective view showing one example of means for discriminating between a plurality of connector-terminal sockets, based on the dummy terminal 10 according to the first embodiment, and FIG. 18 is an explanatory perspective view showing another example of the means for discriminating between a plurality of connector-terminal sockets, based on the dummy terminal 10 according to the second embodiment. FIG. 19 is an explanatory perspective view showing another example of the means for discriminating between a plurality of connector-terminal sockets, based on the dummy terminal 10 according to the third embodiment, and FIG. 20 is an explanatory perspective view showing another example of the means for discriminating between a plurality of connector-terminal sockets, based on the dummy terminal 10 according to the fourth embodiment.

With reference to FIG. 17, a dummy terminal having means for discriminating between a plurality of connector-terminal sockets will be specifically described in connection with one example based on the first embodiment. In FIG. 17, the same component or element as that of the first embodiment is defined by the same reference numeral. This dummy terminal 10 comprises a dummy terminal body 12, a thin plate member 13, an engagement member 14 and a set screw 30. The dummy terminal body 12 is generally composed of a grooved frame defined by opposite side walls 12A, 12B and top wall 12C, and a front wall 12D formed at a front end of the grooved frame. This dummy terminal body 12 is formed to have approximately same size as that of an insertion portion of a target connector-terminal socket. The thin plate member 13 is generally composed of an anchor portion 13A to be mounted on the front wall 12D, and a restraint portion 13B for placing an engaged state of the engagement member 14 under restraint. The engagement member 14 is mounted on the rear end of the grooved frame of the dummy terminal body 12. The engagement member 14 has an anchor portion 14A fixedly mounted on the dummy terminal body 12, a deformable or flexible portion 14B, an engagement portion 14C and an engagement release portion 14D.

In the dummy terminal 10, a color sticker 111 serving as the discrimination means is attached on the anchor portion 13A. The dummy terminal 10 having the color sticker 111 thereon makes it possible to discriminate between a plurality of connector-terminal sockets each having the dummy terminal 10 inserted therein, on a type-by-type basis, for example, between one or more authorized connector-terminal sockets and one or more unauthorized connector-terminal sockets on an administrator-by-administrator basis.

With reference to FIG. 18, a dummy terminal having means for discriminating between a plurality of connector-terminal sockets will be specifically described in connection with another example based on the second embodiment. In FIG. 18, the same component or element as that of the second embodiment is defined by the same reference numeral. This dummy terminal 10 comprises an approximately rectangular parallelepiped-shaped dummy terminal body 12, a thin plate member 13, an engagement member 14 and a set screw 30. The dummy terminal body 12 is formed to have approximately same size as that of an insertion portion of a target connector-terminal socket. The thin plate member 13 is swingably fixed to or formed with a front lower edge of the dummy terminal body 12, and the engagement member 14 is fixedly mounted on a rear upper edge of the dummy terminal body 12. The dummy terminal body 12 has a screw hole 12F for threadingly receiving the set screw 30. The screw hole 12F extends from a front surface of the dummy terminal body 12 in a direction perpendicular to the front surface. The thin plate 13 is generally composed of a pivotal portion 12G fixed to or formed with the front lower edge of the dummy terminal body 12, an anchor portion 13A adapted to be swung about the pivotal portion 12G and brought into contact with the front surface of the dummy terminal body 12, and a restraint portion 13B for placing an engaged state of the engagement member 14 under restraint. A cutout 13D for allowing the set screw to penetrate therethrough is formed in an approximately laterally central region of the anchor portion 13A. The cutout 13D extends parallel to a direction from the pivotal portion 12G toward the restraint portion 13B. When the set screw 30 is loosened but not detached, the cutout 13D allows the thin plate member 13 to be swung at an angle corresponding to the level of loosening of the set screw 30.

In this dummy terminal 10, a color sticker 111 serving as the discrimination means is attached on the thin plate member 13. The dummy terminal 10 having the color sticker 111 thereon makes it possible to discriminate between a plurality of connector-terminal sockets each having the dummy terminal 10 inserted therein, on a type-by-type basis, for example, between one or more authorized connector-terminal sockets and one or more unauthorized connector-terminal sockets on an administrator-by-administrator basis.

With reference to FIG. 19, the dummy terminal means for discriminating between a plurality of connector-terminal sockets will be specifically described in connection with yet another example based on the third embodiment. In FIG. 19, the same component or element as that of the third embodiment is defined by the same reference numeral.

This dummy terminal 10 comprises a dummy terminal body 12, and a set screw 30. The dummy terminal body 12 has an approximately rectangular parallelepiped-shaped base 16 adapted to be inserted into a connector-terminal socket, a standing member 17 formed at one end of the base 16 on the opposite side of the other end to be firstly inserted into a connector-terminal socket, and an engagement member 14 which extends approximate Ely parallel to the base, and has a distal end formed as an engagement portion 14A adapted to be engaged with a connector-terminal latching portion of a target connector-terminal socket, and a proximal end connected to the standing member 17. This dummy terminal body 12 is formed to have approximately same size as that of an insertion portion of the connector-terminal socket.

In this dummy terminal 10, a color sticker 111 serving as the discrimination means is attached on the standing member 17. The dummy terminal 10 having the color sticker 111 thereon makes it possible to discriminate between a plurality of connector-terminal sockets each having the dummy terminal 10 inserted therein, on a type-by-type basis, for example, between one or more authorized connector-terminal sockets and one or more unauthorized connector-terminal sockets on an administrator-by-administrator basis.

With reference to FIG. 20, a dummy terminal having means for discriminating between a plurality of connector-terminal sockets will be specifically described in connection with yet another example based on the fourth embodiment. In FIG. 20, the same component or element as that of the fourth embodiment is defined by the same reference numeral.

The dummy terminal 10 comprises a dummy terminal body 12, and a set screw 30. The dummy terminal body 12 has a base 16 adapted to be inserted into a terminal-connector socket, a standing member 17 formed at one end of the base 16 on the opposite side of the other end to be firstly inserted into the connector-terminal socket, an engagement member 14 which extends approximately parallel to the base 16 and has a distal end formed as an engagement portion 14A adapted to be engaged with a connector-terminal latching portion of a target connector-terminal socket, and a proximal end connected to the standing member 17, and a grip member 19 which has a screw-hole defining portion 18 integrated with the base 16 and formed with a screw hole 18A for the set screw 30, and a grip portion 19 for allowing an operator or user to grip it in an operation of inserting and detaching the dummy terminal body 12 into/from the connector-terminal socket. This dummy terminal body 12 is formed to have approximately same size as that of an insertion portion of the connector-terminal socket.

In this dummy terminal 10, a color sticker 111 serving as the discrimination means is attached on the grip member 19. The dummy terminal 10 having the color sticker 111 thereon makes it possible to discriminate between a plurality of connector-terminal sockets each having the dummy terminal 10 inserted therein, on a type-by-type basis, for example, between one or more authorized connector-terminal sockets and one or more unauthorized connector-terminal sockets on an administrator-by-administrator basis.

<Example of Modification>

In the fifth embodiment, a position on which the color sticker attached may be appropriately selected in consideration of convenience for management and distinctiveness. In addition to a color sticker, the discrimination means may include coloring a dummy terminal 10. In this case, the dummy terminal 10 may be entirely colored, or may be partially colored only in a recognizable area. Alternatively, a mark, such as character and/or symbol, may be used as the discrimination means.

Further, plural kinds of set screws as shown in FIGS. 8A to 8C may be used in each of the dummy terminals, as the discrimination means. Particularly, when the special screws are used as the discrimination means, the use of each dummy terminal can be managed based on a special tool only owned by an authorized administrator. In cases where one communication network is managed by a plurality of administrators, the discrimination based on the special screws is an effective method for managing connector-terminal sockets on an administrator-by-administrator basis. It is understood that the discrimination based on plural kinds of set screws 30 may be used in combination with the color sticker in the fifth embodiment or other discrimination means.

### INDUSTRIAL APPLICABILITY

The present invention can provide a dummy terminal capable of being inserted in a lockable manner into a connector-terminal socket, instead of a cable connector terminal, so as to prevent a cable connector terminal from being erroneously inserted into an improper or unauthorized connector-terminal socket which has no cable connector terminal connected thereto.

Further, the present invention can provide a dummy terminal capable of being inserted in a lockable manner into a connector-terminal socket, instead of a cable connector terminal, while allowing each network administrator to distinguish whether or not the connector-terminal socket is an authorized connector-terminal socket.

In addition to a LAN-cable connector-terminal as described in the above embodiments, the dummy connector of the present invention may be used instead of any other connector terminal having an engagement function, such as a modular terminal for telephone lines.

1. A dummy terminal designed to be inserted into a connector-terminal socket originally intended to insertingly receive a connector terminal attached to an end of a signal transmission cable, comprising:
a dummy terminal body adapted to be inserted into said connector-terminal socket;
dummy-terminal engagement means mounted on said dummy terminal body and adapted to be engaged with a connector-terminal latching portion formed in said connector-terminal socket; and
dummy-terminal lock means including a lock member which is mounted on said dummy terminal body and adapted to allow said dummy terminal body after being inserted into said connector-terminal socket, to be locked in its engaged state through said dummy-terminal engagement means.

2. The dummy terminal as defined in claim 1, wherein said dummy-terminal engagement means includes a flexible engagement member having an engagement portion adapted to be engaged with said connector-terminal latching portion.

3. The dummy terminal as defined in claim 1, wherein said dummy-terminal lock means further includes:
a screw hole formed in said dummy terminal body; and
a set screw threadingly engageable with said screw hole in a detachable manner, said set screw being adapted to be tightened so as to allow said dummy terminal body to be locked in said engaged state, and to be loosened so as to allow said dummy terminal body to be released from said lock-in state.

4. The dummy terminal as defined in claim 1, wherein said lock member of said dummy-terminal lock means is swingably mounted on said dummy terminal body.

5. A dummy terminal designed to be inserted into a connector-terminal socket originally intended to insertingly receive a connector terminal attached to an end of a signal transmission cable, comprising:
a dummy terminal body adapted to be inserted into said connector-terminal socket, said dummy terminal body having a base, an upstanding segment extending upward from said base, an engagement segment which extends approximately parallel to said base, and has a distal end formed as an engagement portion adapted to be engaged with and latched by a connector-terminal latching portion formed in said connector-terminal socket and a proximal end connected to said upstanding segment; and
dummy-terminal release means for releasing a latched state of said dummy terminal body after being inserted into said connector-terminal socket.

6. The dummy terminal as defined in claim 5, wherein said dummy-terminal release means includes:
a screw hole formed in said dummy terminal body; and
a set screw threadingly engageable with said screw hole in a detachable manner, said set screw being adapted to be loosened so as to allow said dummy terminal body to be placed in said latched state, and to be tightened so as to allow said dummy terminal body to be released from said latched state.

7. A dummy terminal designed to be inserted into a connector-terminal socket originally intended to insertingly receive a connector terminal attached to an end of a signal transmission cable, comprising:
a dummy terminal body adapted to be inserted into said connector-terminal socket, said dummy terminal body having a base, an upstanding segment extending upward from said base, an engagement segment which extends approximately parallel to said base, and has a distal end formed as an engagement portion adapted to be engaged with a connector-terminal latching portion formed in said connector-terminal socket and a proximal end connected to said upstanding segment; and
dummy-terminal lock means mounted on said dummy terminal body and adapted to allow said dummy-terminal body after being inserted into said connector-terminal socket, to be locked in its engaged state through said engagement portion.

8. The dummy terminal as defined in claim 7, wherein said dummy-terminal lock means includes:
a screw hole formed in said dummy terminal body; and
a set screw threadingly engageable with said screw hole in a detachable manner, said set screw being adapted to be tightened so as to allow said dummy terminal body to be locked in said engaged state, and to be loosened so as to allow said dummy terminal body to be released from said lock-in state.

9. The dummy terminal as defined in claim 1, which includes discrimination means for discriminating between a plurality of connector-terminal socket.

10. The dummy terminal as defined in claim 9, wherein said discrimination means includes at least one selected from the group consisting of a color sticker, a special screw and a coloring material.
